(19) United States
(12) Patent Application Publication
(10) Pub. No.: US 2009/0129752 A1
(43) Pub. Date: May 21, 2009

(54) Playback Device, Repeated Playback Method For The Playback Device, And Program

(75) Inventors: Takao Yamada, Tokyo (JP); Takashi Suzuki, Tokyo (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 12/300,663

(22) PCT Filed: May 17, 2006
(86) PCT No.: PCT/JP2006/309862

§ 371 Date: Nov. 13, 2008

(51) Int. Cl. H04N 5/91

(52) U.S. Cl. 386/102; 386/E05.003

(57) ABSTRACT

A playback device and the like that can perform repeated playback without lowering video quality to perform the repeated playback while synchronizing audio data with video data, includes a unit 71 that specifies an IN point as a start position and an OUT point as an end position of repeated playback on a temporal axis of audio data, a unit 81 that registers each of the specified points, a unit 82 that decides a video frame corresponding to an address of the specified IN point as an IN point frame and a video frame corresponding to an address of the specified OUT point as an OUT point frame, and a unit 83 that limits a video frame to be output to a playback segment of the repeated playback to a video frame positioned between the IN point frame and the OUT point frame on a temporal axis of video data.

### TECHNICAL FIELD

The present invention relates to a playback device that performs repeated playback while synchronizing audio data with video data, a repeated playback method for the playback device, and a program.

### BACKGROUND ART

With audio data recorded on a predetermined medium, a repeated playback method that repeatedly plays back between any two points of a recording position has been known (for example, refer to Patent Document 1). The repeated playback is often carried out as one of performances presented by disc jockeys (DJ), for example, in clubs, and the DJ keeps tension on the floor by carrying out such a performance. In recent years, in the clubs and the like, not only sound, but also videos such as a promotion video are displayed on a monitor in the hall to the sound.

### [Patent Document 1] JP-A-07-065506

### DISCLOSURE OF THE INVENTION

### Problems to be Solved

When sound is repeatedly played back while an optional video is being displayed to the sound as described above, it is obviously preferable to play back the video repeatedly, while synchronizing with the repeated playback of the sound. For example, a video frame that includes a time stamp closest to the time stamp of the output audio frame may be output. However, frame frequencies of the audio data and the video data are often not the same nor equal to the integral multiple. Accordingly, it is difficult to keep the correlation between the audio frame and the video frame. Even if both frame frequencies are adjusted to be the same (or equal to integral multiple), if the audio data can be played back in variable speed or played back in reverse, it accordingly becomes difficult to uniquely correlate the audio frame with the video frame.

Therefore, especially because the video frame with respect to the audio frame at the repeat start position and the repeat end position is not uniquely defined, an unexpected different type of video frame may sometimes be output at the repeat start position and the end position. The brief output of the different type of frame becomes a flicker in a video image, thereby degrading the video quality.

In view of the above-described problems, the present invention provides a playback device that can perform repeated playback without lowering video quality to perform the repeated playback while synchronizing audio data with video data, a repeated playback method for the playback device, and a program.

### Means to Solve the Problems

A playback device of the present invention enters audio data and video data, and performs repeated playback both data while synchronizing the audio data with the video data. The playback device includes a point specifying unit that specifies an IN point that is a repeat start position of the repeated playback and an OUT point that is a repeat end position of the repeated playback, respectively on a temporal axis of the audio data, a point registering unit that registers the specified IN point and OUT point, a point frame deciding unit that, from each video frame of the input video data, decides a video frame corresponding to an address of the specified IN point as an IN point frame, and decides a video frame corresponding to an address of the specified OUT point as an OUT point frame, and an output frame limiting unit that limits a video frame to be output to a playback segment of the repeated playback to a video frame positioned between the decided IN point frame and OUT point frame on a temporal axis of the video data.

Similarly, a repeated playback method for a playback device of the present invention enters audio data and video data, synchronizes the audio data with the video data, and performs repeated playback of both data between an IN point that is a repeat start position of repeated playback and an OUT point that is a repeat end position of repeated playback specified on a temporal axis of the audio data. The repeated playback method includes deciding a point frame that, from each video frame of the input video data, decides a video frame corresponding to an address of the IN point as an IN point frame and decides a video frame corresponding to an address of the OUT point as an OUT point frame, and limiting an output frame that limits a video frame to be output to a playback segment of the repeated playback to a video frame positioned between the decided IN point frame and OUT point frame on a temporal axis of the video data.

With these configurations, video frames output to the repeated playback segment can be limited to video frames positioned between the decided IN point frame and OUT point frame on the temporal axis of the video data. Accordingly, even if a video frame with respect to an audio frame is not uniquely defined, an unexpected different type of video frame will not be output at the repeat start position and end position. In other words, it is possible to perform repeated playback while synchronizing the video data with the audio data, without lowering video quality, which will result in a flicker in a video image, for example.

In the above-mentioned playback device, if the IN point and/or the OUT point are specified by the point specifying unit while the audio data and the video data are being played back, it is preferable that the point frame deciding unit decide a video frame that is output while the point is specified, as the IN point frame and/or the OUT point frame.

With this configuration, it is possible to easily decide each point frame. Because the point is specified while the audio data and the video data are being played back, a user can easily identify the video frame decided as the IN point frame or the OUT point frame.

In the above-mentioned playback device, it is preferable that the output frame limiting unit, at an output timing of the video frame in the playback segment of the repeated playback, if a video frame to be output is positioned before the IN point frame on the temporal axis of the video data, forcibly output the IN point frame, and if the video frame is positioned after the OUT point frame on the temporal axis of the video data, forcibly output the OUT point frame.

With this configuration, the IN point frame and the OUT point frame are not fixedly output at the repeat start position and the repeat end position. Instead, the IN point frame and the OUT point frame are forcibly output, only when the video frame to be output is positioned before the IN point frame (after the OUT point frame) on the temporal axis of the video data. Accordingly, it is possible to perform repeated playback, without changing the output sequence of video frames as much as possible.

In the above-mentioned playback device, it is preferable to further include a point correcting unit that corrects the specified IN point and/or OUT point. It is also preferable that the point frame deciding unit, when the IN point is corrected by the point correcting unit, decide the IN point frame based on a time stamp of an old IN point frame decided based on the IN point before being corrected and an address of the IN point after being corrected, and when the OUT point is corrected by the point correcting unit, decide the OUT point frame based on a time stamp of an old OUT point frame decided based on the OUT point before being corrected and an address of the OUT point after being corrected.

With this configuration, it is possible to finely adjust each point position by using the correcting unit, if a user desires to shift the IN point or the OUT point to the vicinity of the specified points, in other words, if the user desires to finely adjust the specified point position. It is also possible to re-decide the point frame anew with the correction. By calculating a time stamp of each video frame based on the time stamp of the old point frame, a calculating process becomes easy. Accordingly, it is possible to effectively decide the point frame that corresponds to the point after being corrected.

In the above-mentioned playback device, it is preferable to further include a frame specifying unit that directly specifies a video frame for the IN point frame and/or the OUT point frame. It is also preferable that the point frame deciding unit decide the video frame specified by the frame specifying unit as the IN point frame and/or the OUT point frame.

With this configuration, a user can directly specify and decide the IN point frame and/or the OUT point frame. Accordingly, it is possible to limit video frames output to the repeated playback segment, to video frames within the segment that the user desires.

In the above-mentioned playback device, it is preferable that the repeated playback include a repeat in a fixed playback direction that is a forward direction or a backward direction starting from either the IN point or the OUT point, and a repeat in a switched playback direction that is switched alternatively between the forward direction and the backward direction starting alternatively from the IN point and the OUT point.

With this configuration, it is possible to apply the present invention to various repeated playback methods.

A computer program according to the present invention enables a computer to function as each unit included in any one of the above-mentioned playback devices.

By using the program, it is possible to realize a playback device that can perform repeated playback without lowering video quality to perform the repeated playback while synchronizing audio data with video data.

### BRIEF DESCRIPTION OF THE DRAWINGS

FIG. 1 is a block diagram of a playback device.

FIG. 2 shows schematic diagrams of an audio frame buffer and a video frame buffer.

FIG. 3 is a functional block diagram of the playback device.

FIG. 4 is a schematic diagram for explaining a deciding process of an IN point frame and an OUT point frame.

FIG. 5 is a schematic of an output range of a video frame while being repeatedly played back.

FIG. 6 shows schematics for explaining a plurality of types of repeated playback methods.

FIG. 7 is a flowchart showing a registration procedure of an IN point and an OUT point.

FIG. 8 is a flowchart showing an output procedure of the video frame while being repeatedly played back.

FIG. 9 is schematics of the other decided examples of the IN point frame and the OUT point frame.

### REFERENCE NUMERALS

1 playback device
10 playback controlling section
11 input unit
12 separating unit
13 audio combining unit
14 audio memory controlling unit
15 audio output unit
16 video combining unit
17 video memory controlling unit
18 video output unit
20 audio memory
21 audio frame buffer
22 IN point buffer (audio)
23 OUT point buffer (audio)
30 video memory
31 video frame buffer
32 IN point buffer (video)
33 OUT point buffer (video)
50 operating/displaying section
51 display
52 instruction button
53 operation dial
60 CPU
71 point specifying unit
72 point correcting unit
81 point registering unit
82 point frame deciding unit
83 output frame limiting unit
As time stamp (audio)
At temporal axis (audio)
Vs time stamp (video)
Vt temporal axis (video)

### BEST MODES FOR CARRYING OUT THE INVENTION

Exemplary embodiments of a playback device, a repeated playback method for the playback device, and a program according to an embodiment of the present invention will be described in detail below with reference to the accompanying drawings. The playback device according to the present invention enters audio data and video data, and repeatedly plays back both data, while synchronizing the input audio data with the video data. As the playback device according to the present invention, a DVJ equipment (combined equipment composed of a DJ equipment used for acoustic performance by a disc jockey (DJ), and a VJ equipment used for video performance by a visual jockey or a video jockey (VJ)) that can handle audio data and video data as if they are instruments is applied and explained.

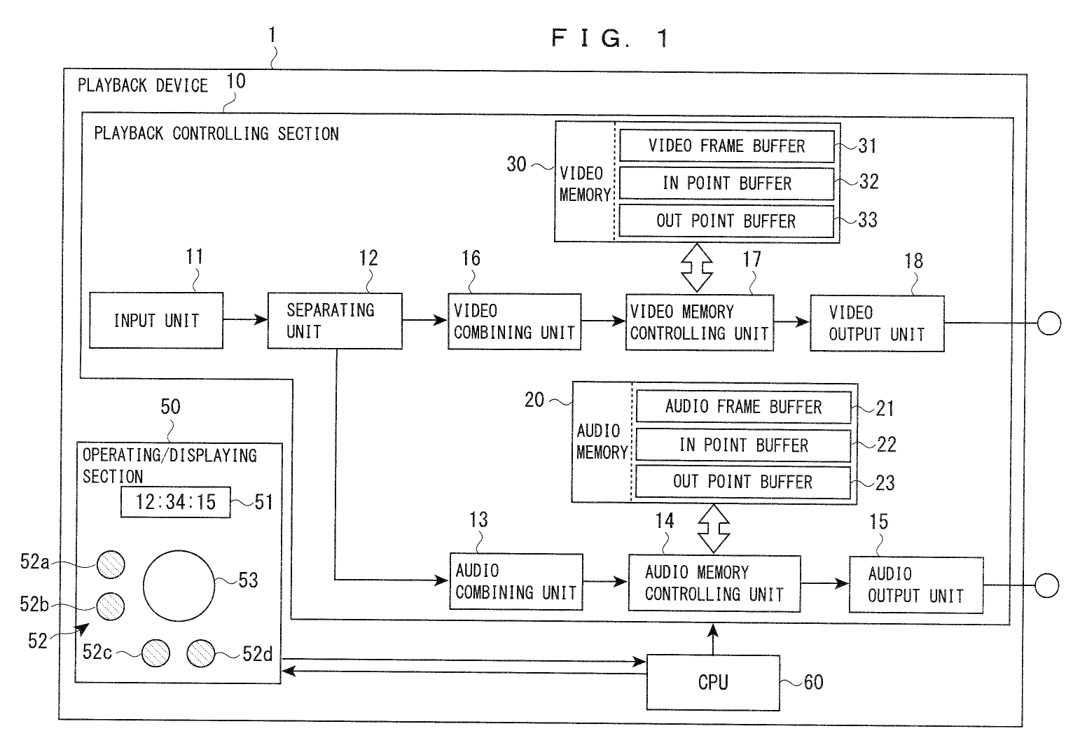

FIG. 1 is a block diagram of a playback device 1 according to the present embodiment. As shown in the diagram, the playback device 1 includes a playback controlling section 10 that controls playback of audio data and video data, an operating/displaying section 50 that functions as a user interface, and a CPU 60 that integrally controls the entire playback device 1.

The playback controlling section 10 includes an input unit 11, a separating unit 12, an audio combining unit 13, an audio memory 20, an audio memory controlling unit 14, an audio output unit 15, a video combining unit 16, a video memory 30, a video memory controlling unit 17, and a video output unit 18.

The input unit 11, for example, is formed by either one of a DVD drive, a CD drive, a hard disc drive, or a semiconductor memory. The input unit 11 reads out contents (audio data and video data) stored in a predetermined recording medium (storage), and enters into the playback device 1. The separating unit 12 separates the audio data (audio stream) from the video data (video stream) entered from the input unit 11.

The audio combining unit 13 combines the compressed audio stream with the audio frame. The audio memory 20 includes an audio frame buffer 21 that temporarily stores therein the audio frame combined by the audio combining unit 13, and an IN point buffer 22 and an OUT point buffer 23, which will be described later. The audio memory controlling unit 14 controls the writing and the reading of the audio frame with respect to the audio memory 20 (audio frame buffer 21, IN point buffer 22, and OUT point buffer 23). The audio output unit 15 incorporates the audio frame from the audio memory 20, converts to an audio signal, and outputs thereof.

The video combining unit 16 combines the compressed video stream with the video frame. The video memory 30 includes a video frame buffer 31 that temporarily stores therein the video frame combined by the video combining unit 16, and an IN point buffer 32 and an OUT point buffer 33, which will be described later. The video memory controlling unit 17 controls the writing and the reading of the video frame with respect to the video memory 30 (video frame buffer 31, IN point buffer 32, and OUT point buffer 33). The video output unit 18 incorporates the video frame from the video memory 30, converts to a video signal, and outputs thereof. If the audio data and the video data of the contents are recorded uncompressed, the video combining unit 16 and the audio combining unit 13 may be omitted.

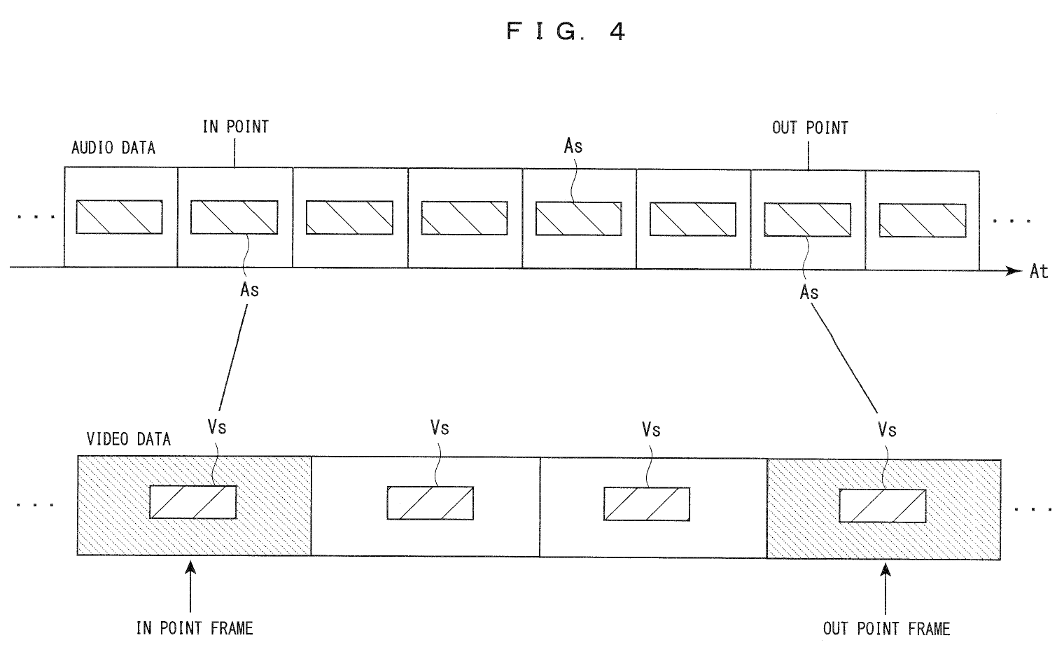

The operating/displaying section 50 includes a display 51 that displays various types of information, an instruction button 52, and an operation dial 53. The display 51 displays an address of the audio data being played back, or when the audio data and the video data are repeatedly played back, displays an address and the like of an IN point, which is the start position, or an OUT point, which is the end position of the repeated playback. The instruction button 52 includes an IN point register button 52a, when the audio data and the video data are repeatedly played back, used to specify an IN point, which is the start position, on a temporal axis At of the audio data (see FIG. 4), and includes an OUT point register button 52b used similarly to specify an OUT point, which is the end position of the repeated playback. The instruction button 52 also includes an IN point correction button 52c used to instruct the correction of the registered IN point and an OUT point correction button 52d used similarly to instruct the correction of the registered OUT point. The operation dial 53 is used as an operator for adjusting each point, mainly when the IN point and the OUT point are corrected.

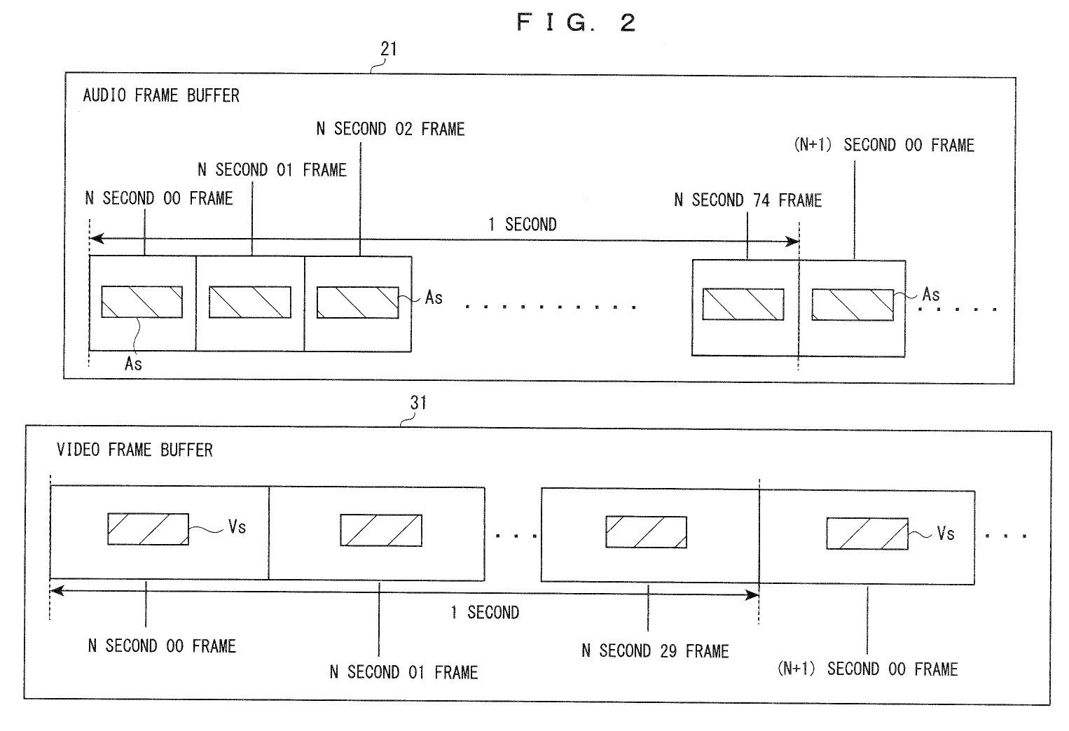

A playback operation of the audio data and the video data performed by the playback device 1 will now be described with reference to FIG. 2. As described above, in the audio frame buffer 21 of the audio memory 20, audio frames combined by the audio combining unit 13 are stored temporarily. At this time, a unique time stamp As is assigned to each of the audio frames. The audio frames may be combined with any frame, irrespective of the unit of encoding/combining (in the present embodiment, one frame is 1/75 seconds). In this case, an assigning method of the time stamp As may be performed, for example, by storing a time stamp written on the audio stream before being combined, and assigning the time stamp As to each audio frame combined based on thereof. A user then identifies the time stamp As assigned to each of the audio frames, as an address on the temporal axis of the audio data. In the present embodiment, this time stamp As can be used as a time stamp to synchronize the video data with the audio data, without any changes.

Similarly, in the video frame buffer 31 of the video memory 30, video frames (in the diagram, one frame is 1/30seconds) combined by the video combining unit 16 are temporarily stored, and a unique time stamp Vs is assigned to each of the video frames at this time. In this case also, for example, the time stamp written on the video stream before being combined may be stored therein, and the time stamp Vs of each video frame combined based on thereof may be calculated and assigned.

The synchronization and playback of the audio data and the video data are controlled under the CPU 60. Describing a specific procedure, the CPU 60 instructs a playback speed instructed by a user in advance to the audio output unit 15. The audio output unit 15, based on the instructed playback speed, incorporates the audio frame via the audio memory controlling unit 14, and outputs as needed. At the same time, the CPU 60, at the output timing of the video frame, searches a video frame that includes the time stamp Vs closest to the time stamp As of the audio frame being output, from the video frames stored in the video frame buffer 31, via the video memory controlling unit 17, and outputs thereof to the video output unit 18.

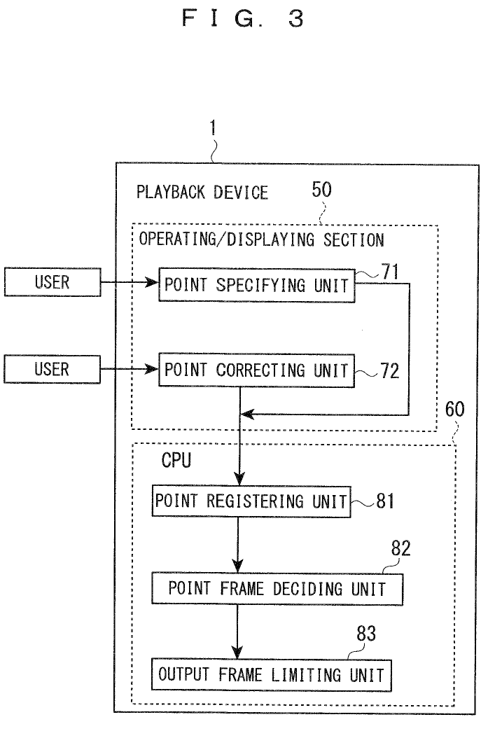

A functional configuration of the playback device 1 according to the present embodiment will now be described with reference to FIG. 3. As shown in the diagram, the playback device 1 includes a point specifying unit 71, a point registering unit 81, a point frame deciding unit 82, an output frame limiting unit 83, and a point correcting unit 72. The point specifying unit 71 includes the IN point register button 52a, the OUT point register button 52b, and the operation dial 53 shown in FIG. 1. The point specifying unit 71 is a unit by which a user specifies an IN point, which is a repeat start position, and an OUT point, which is a repeat end position, in the repeated playback, on the temporal axis At of the audio data (see FIG. 4).

More specifically, the IN point register button 52a and the OUT point register button 52b are used to instruct the registration of each point, and the operation dial 53 is used to specify the address of the IN (OUT) point. However, if a user operates the IN point register button 52a or the OUT point register button 52b while the audio data and the video data are being played back, the operation dial 53 does not need to specify the address.

The point registering unit 81 respectively holds the addresses (time stamp As of audio frame positioned at IN point and OUT point) of the specified IN point and OUT point, which are specified by the point specifying unit 71 as the IN point and the OUT point. The point frame deciding unit 82 decides a video frame that corresponds to the address of the specified IN point as an IN point frame, and also decides a video frame that corresponds to the address of the specified OUT point as an OUT point frame.

Describing more specifically with reference to FIG. 4, in each video frame stored in the video frame buffer 31, the time stamp Vs unique to each frame is being calculated. Accordingly, by referring to the time stamp Vs of each video frame, a video frame that includes the time stamp Vs closest to the time stamp As of the audio frame positioned at the IN point (OUT point) is decided as the IN point (OUT point) frame. Subsequently, each time stamp Vs of the decided IN point frame and OUT point frame is held therein.

Because a frame frequency of the video frame is constant, it is also possible to calculate the time stamp Vs of the video data (frame) positioned before (after) each of the video frames stored in the video frame buffer 31, specifies the time stamp Vs closest to the address of the IN point (OUT point) from the calculated time stamps Vs, and decide the video frame assigned with the specified time stamp Vs as the IN point (OUT point) frame.

When the IN point and/or the OUT point are specified especially while the video data and the audio data are being played back, instead of using the frame deciding method, the point frame deciding unit 82, decides the video frame being output by the video output unit 18 while the IN point and/or the OUT point are being specified, as the IN point frame and/or the OUT point frame.

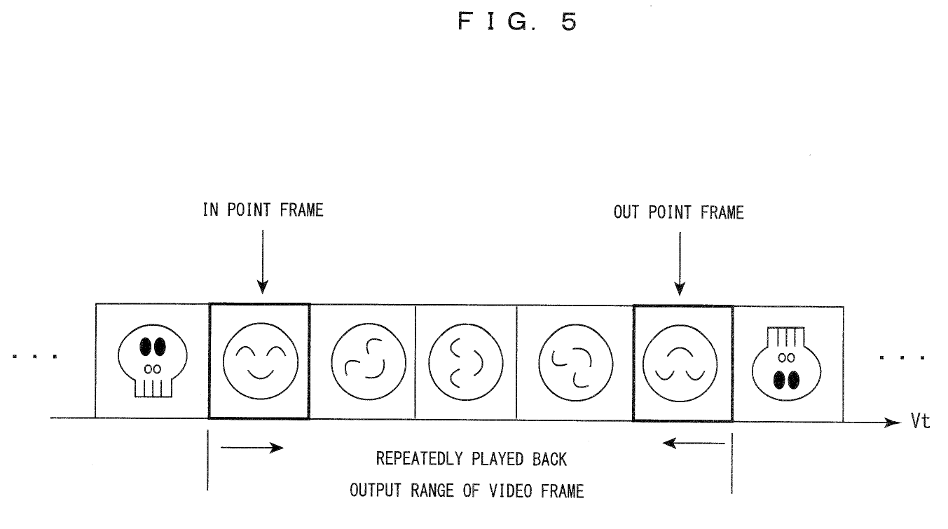

The output frame limiting unit 83 limits video frames output to the playback segment of the repeated playback between the IN point and the OUT point, to video frames positioned between the decided IN point frame and OUT point frame, on the temporal axis Vt of the video data (see FIG. 5). In other words, in the repeated playback segment, the output frame limiting unit 83 determines whether a video frame to be output is the video frame positioned between the IN point frame and the OUT point frame as needed, at each output timing of the video frame. If this is not the case, the output frame limiting unit 83 performs the control to forcibly output the IN point frame or the OUT point frame.

The above-mentioned point registering unit 81, the point frame deciding unit 82, and the output frame limiting unit 83 are all included in the CPU 60 as the main components.

The point correcting unit 72 includes the IN point correction button 52c, the OUT point correction button 52d, and the operation dial 53 shown in FIG. 1. The point correcting unit 72 is a unit by which a user corrects the specified IN point and OUT point.

When the IN point and/or the OUT point are corrected by the point correcting unit 72, the point registering unit 81 registers a new IN point and/or a new OUT point after being corrected, anew. At the same time, the point frame deciding unit 82 performs a process of re-deciding an IN point frame and/or a new OUT point frame, based on the new IN point and/or the new OUT point after being corrected. In this case, to identify the video frame that includes the time stamp Vs close to the address of the new IN point (new OUT point) after being corrected, the point frame deciding unit 82 uses the time stamp Vs of an old IN point frame (old OUT point frame) decided before being corrected.

For example, if the new IN point after being corrected is positioned before the old IN point on the temporal axis At of the audio data, the time stamp Vs of each video frame positioned before the old IN point frame is calculated on the temporal axis Vt of the video data, based on the time stamp Vs of the old IN point frame. The video frame that includes the time stamp Vs closest to the address of the new IN point after being corrected is then decided as a new IN point frame. It is also possible to decide the new IN point frame, without using the time stamp Vs of the old IN point frame.

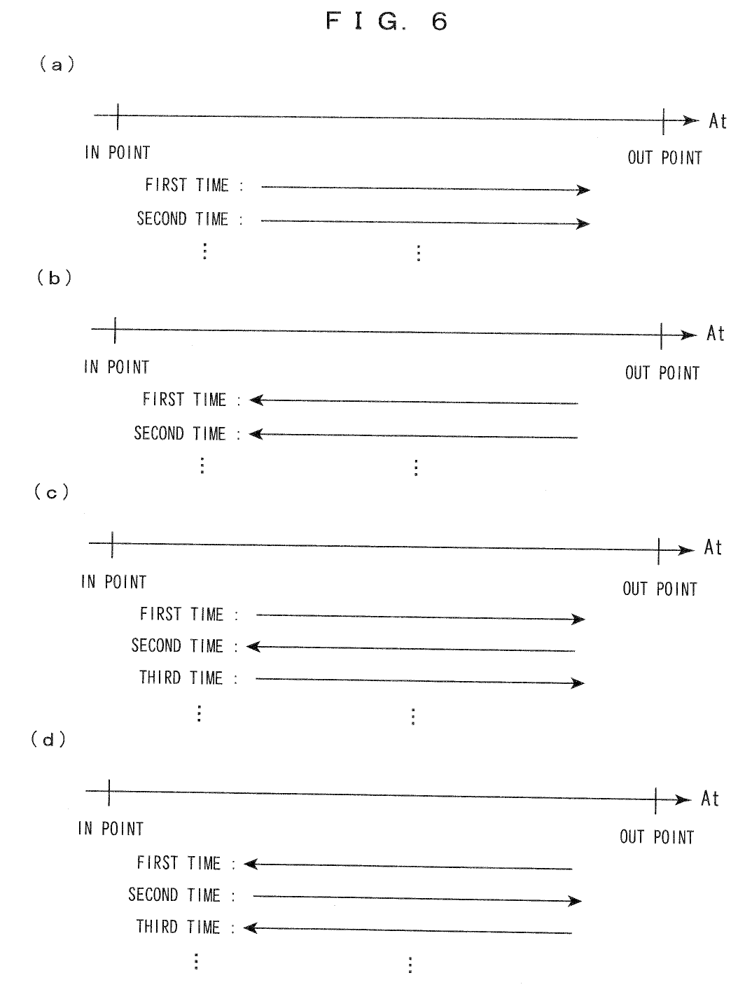

The playback device 1 according to the present embodiment, as shown in FIG. 6, includes four types of repeat playback modes, as the repeated playback between the registered IN point and the OUT point. More specifically, the repeat playback modes include a repeat in a fixed playback direction (see (a) and (b) in the diagram) that is a forward direction or a backward direction starting from either the IN point or the OUT point, and a repeat in a switched playback direction (see (c) and (d) in the diagram) that is switched alternatively between the forward direction and the backward direction starting alternatively from the IN point and the OUT point.

Especially in the repeated playback using the repeat with fixed playback direction, to enable a seamless repeated playback, with the registration of the IN point and the OUT point, the playback device 1 (CPU 60) stores a plurality of audio frames positioned at the registered IN point and the vicinity thereof in the IN point buffer 22 of the audio memory 20, and a plurality of video frames positioned at the decided IN point frame and the vicinity thereof in the IN point buffer 32 of the video memory 30. The playback device 1 (CPU 60) also stores a plurality of audio frames positioned at the registered OUT point and the vicinity thereof in the OUT point buffer 23 of the audio memory 20, and a plurality of video frames positioned at the decided OUT point frame and the vicinity thereof in the OUT point buffer 33 of the video memory 30.

In other words, for example, in the repeated playback shown in FIG. 6(a), when the playback position has moved to the IN point from the OUT point, the audio frame stored in the IN point buffer 22 and the video frame stored in the IN point buffer 32 are sequentially output. Until the audio frame stored in the IN point buffer 22 and the video frame stored in the IN point buffer 32 are completely output, the CPU 60 performs a process of incorporating the subsequent audio data and the video data in the audio frame buffer 21 or the video frame buffer 31. The number of the audio and the video frames stored in each buffer is optional.

In the IN point buffer 22 of the audio memory 20, not only the audio frame subsequent to the registered IN point, but also the audio frame positioned before the IN point is stored. In the IN point buffer 32 of the video memory 30, not only the video frame subsequent to the decided IN point frame, but also the video frame positioned before the IN point frame is stored. Accordingly, even if the IN point is corrected to the position outside the repeated playback segment, while being repeatedly played back, it is possible to continue seamless repeated playback (however, restricted to when the corrected IN point is positioned in the frame range stored in the IN point buffer 22 of the audio memory 20). The same applies for the OUT point buffers 23 and 33.

For example, in the repeated playback shown in FIG. 6(a), even if the corrected IN point is positioned outside the frame range stored in the IN point buffer 22 of the audio memory 20, it is possible to continue seamless repeated playback. This is enabled by incorporating the audio frame positioned near the corrected IN point and the video frame that corresponds thereto, when the playback position reaches the range of the audio frame and the video frame stored in the OUT point buffers 23 and 33 (same applies in the repeated playback shown in FIG. 6(b), when the corrected OUT point is positioned outside the frame range stored in the OUT point buffer 23 of the audio memory 20).

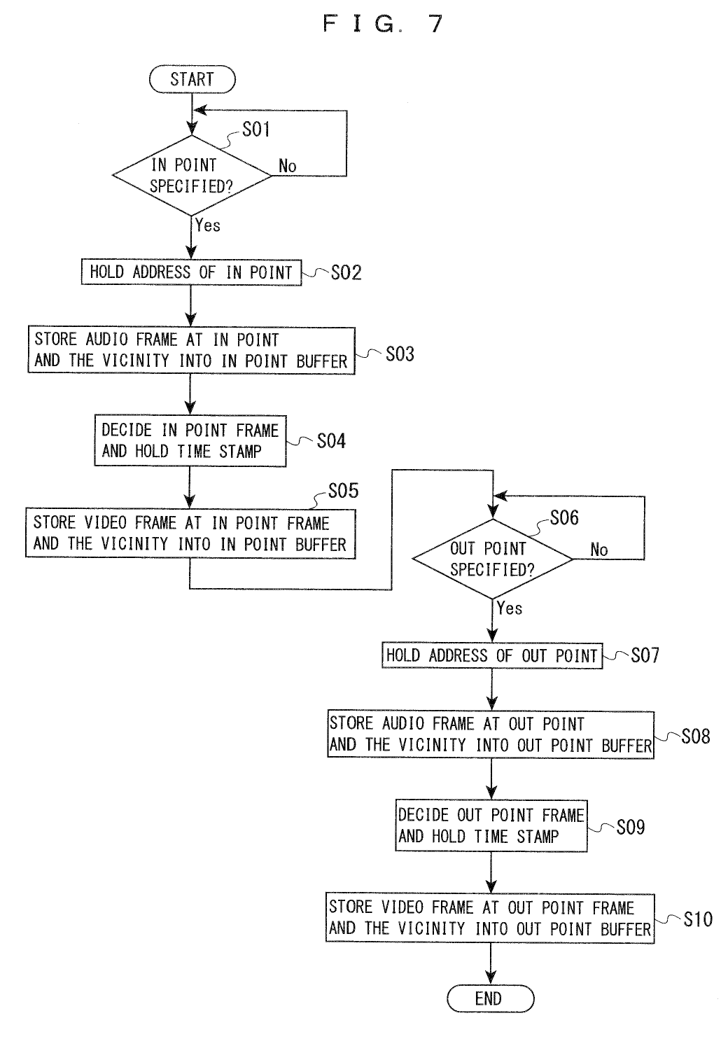

A flow of registering the IN point and the OUT point will be described with reference to a flowchart shown in FIG. 7. As shown in the diagram, if the point specifying unit 71 specifies the IN point on the temporal axis At of the audio data (Yes at S01), the CPU 60 holds the address of the specified IN point (S02), and stores a plurality of audio frames positioned at the IN point and the vicinity thereof in the IN point buffer 22 of the audio memory 20 (S03). The CPU 60 also decides the IN point frame based on the address of the specified IN point, holds the time stamp Vs of the decided IN point frame (S04), and stores a plurality of video frames positioned at the decided IN point frame and the vicinity thereof in the IN point buffer 32 of the video memory 30 (S05).

Subsequently, if the point specifying unit 71 specifies the OUT point on the temporal axis At of the audio data (Yes at S06), the CPU 60 holds the address of the specified OUT point (S07), and stores a plurality of audio frames positioned at the OUT point and the vicinity thereof in the OUT point buffer 23 of the audio memory (S08). The CPU 60 then decides the OUT point frame based on the address of the specified OUT point, holds the time stamp Vs of the decided OUT point frame (S09), and stores a plurality of video frames positioned at the decided OUT point frame and the vicinity thereof in the OUT point buffer 33 of the video memory 30 (S10).

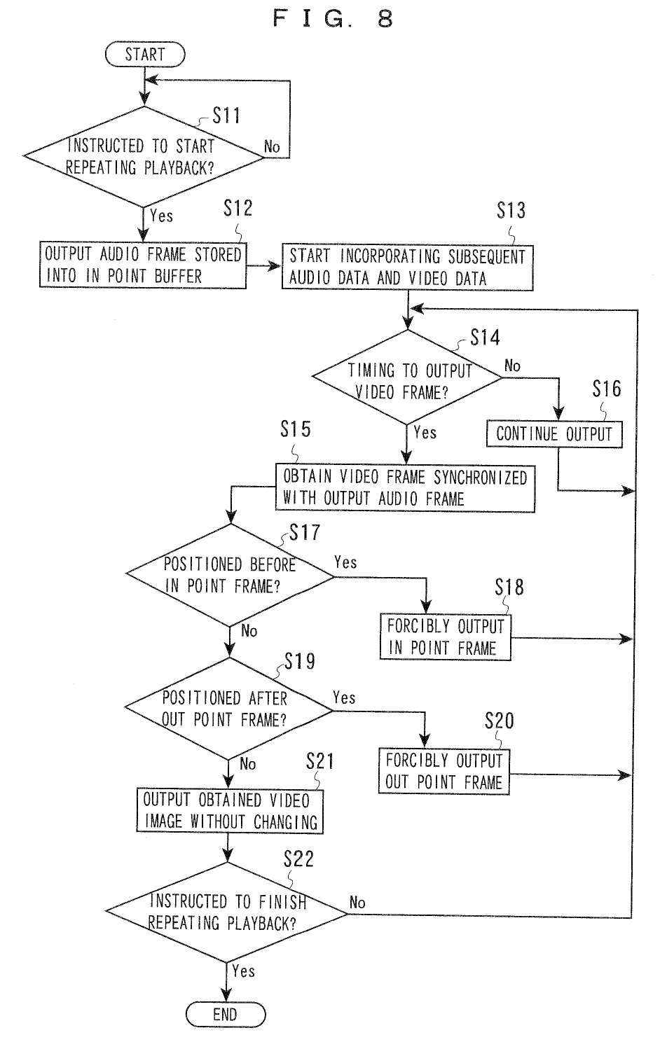

A flow of the repeated playback between the registered IN point and the OUT point will now be explained with reference to a flowchart shown in FIG. 8. In the following, the repeated playback shown in FIG. 6(a), in other words, the repeated playback originating from the IN point and repeated by fixing the playback direction in the forward direction will be explained.

At first, for example, when a user instructs to start repeated playback by a predetermined operation (Yes at S11), the audio output unit 15 starts outputting the audio frame stored in the IN point buffer 22 of the audio memory 20 (S12). The CPU 60 then starts the process of incorporating the subsequent audio data and the video data (S13). The CPU 60, at the output timing of the video data (Yes at S14), from the video frames stored in the video frame buffer 31, obtains the video frame that includes the time stamp Vs closest to the time stamp As of the audio frame being output, in other words, the video frame that synchronizes with the audio frame being output, via the video memory controlling unit 17 (S15). The CPU 60 keeps outputting the audio data (S16), until the output timing of the video data (No at S14).

On obtaining the video frame, the CPU 60 determines whether the obtained video frame is positioned before the IN point frame decided at registering the IN point, on the temporal axis Vt of the video data (S17). If the obtained video frame is positioned before the IN point frame (Yes at S17), the CPU 60 forcibly outputs the IN point frame instead of the obtained video frame, with respect to the video output unit 18 (S18). If the obtained video frame is not positioned before the IN point frame (No at S17), the CPU 60 further determines whether the obtained video frame is positioned after the OUT point frame decided at registering the OUT point (S19).

If the obtained video frame is positioned after the OUT point frame (Yes at S19), the CPU 60 forcibly outputs the OUT point frame instead of the obtained video frame with respect to the video output unit 18 (S20). If the obtained video frame is not positioned after the OUT point frame (No at S19), in other words, if the obtained video frame is positioned between the IN point frame and the OUT point frame on the temporal axis Vt of the video data, the CPU 60 outputs the obtained video frame without any changes (S21). These processes are repeated, until an instruction to end the repeated playback is received (Yes at S22).

As explained above, in the playback device 1 according to the present embodiment, video frames output to the repeated playback segment can be limited to video frames positioned between the decided IN point frame and OUT point frame, on the temporal axis Vt of the video data. Therefore, even if the video frame with respect to the audio frame is not uniquely defined, an unexpected different type of video frame will not be output, at the repeat start position and the end position. In other words, the repeated playback can be performed while synchronizing the video data with the audio data, without degrading video quality, which will result in a flicker, for example.

The IN point frame and the OUT point frame may be formed so as a user can specify directly. The control will now be described below. In this case, in addition to the configuration of the operating/displaying section 50 shown in FIG. 1, the playback device 1 may include an IN point frame changing instruction button (not shown) and an OUT point frame changing instruction button (not shown) (frame specifying unit). For example, if a user operates the IN point frame changing instruction button or the OUT point frame changing instruction button while the video data is being played back, the point frame deciding unit 82 decides the video frame being output when the button is operated, as the IN point frame or the OUT point frame.

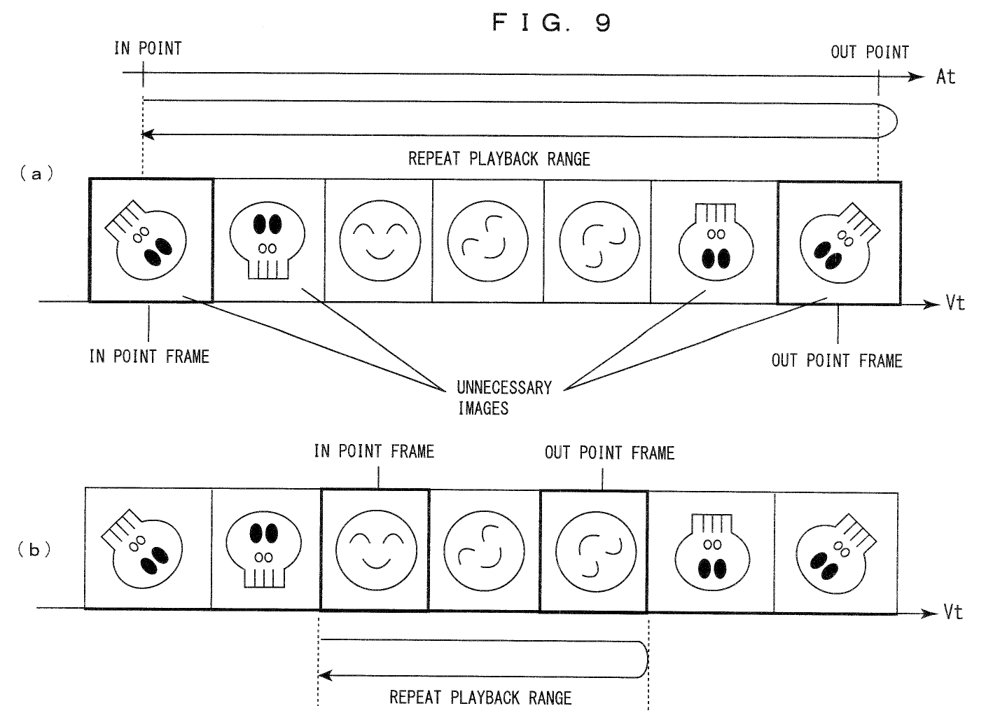

With this configuration, the user can directly specify and decide the IN point frame and/or the OUT point frame. Accordingly, it is possible to limit video frames output to the repeated playback segment to video frames included in the segment intended by the user. In other words, it is possible to determine the repeated playback segment of the video data, without depending on the repeated playback segment of the audio data. For example, as shown in FIG. 9(a), if unnecessary images that the user does not desire to playback are included between the IN point frame and the OUT point frame, decided based on the addresses of the specified IN point and OUT point on the temporal axis At of the audio data, as shown in (b) in the diagram, it is possible to limit the repeated playback segment of the video frame in the range desired by the user.

The IN point buffer 22 and the OUT point buffer 23 need not be physically included in the audio memory 20. The audio frames that should be stored in the IN point buffer 22 and the OUT point buffer 23 may be stored in the audio frame buffer 21, thereby making the audio frames incapable of being written. The same applies for the video memory 30.

Each function included in the playback device 1 shown in the above examples can be provided as a program. The program can also be stored and provided in a recording medium (not shown). Examples of such recording medium include: a CD-ROM, a flash ROM, a memory card (such as a compact flash (trademark), a smart media, and a memory stick), a compact disc, a magneto-optical disc, a digital versatile disc, and a flexible disc.

The device configuration, the processing steps, and the like may not be limited to the above-described examples of the playback device 1 according to the embodiment, but may be modified suitably within the spirit and scope of the present invention.

1. A playback device that enters audio data and video data, and performs repeated playback of both data while synchronizing the audio data with the video data, the playback device comprising:
a point specifying unit that specifies an IN point that is a repeat start position of the repeated playback and an OUT point that is a repeat end position of the repeated playback, respectively on a temporal axis of the audio data; a point registering unit that registers the specified IN point and OUT point; a point frame deciding unit that, from each video frame of the input video data, decides a video frame corresponding to an address of the specified IN point as an IN point frame, and decides a video frame corresponding to an address of the specified OUT point as an OUT point frame; and an output frame limiting unit that limits a video frame to be output to a playback segment of the repeated playback to a video frame positioned between the decided IN point frame and OUT point frame on a temporal axis of the video data.

2. The playback device according to claim 1, wherein if any one of the IN point and the OUT point or both is specified by the point specifying unit while the audio data and the video data are being played back, the point frame deciding unit decides a video frame that is output while the point is specified, as any one of the IN point frame and the OUT point frame or both.

3. The playback device according to claim 1, wherein the output frame limiting unit, at an output timing of a video frame in the playback segment of the repeated playback, if a video frame to be output is positioned before the IN point frame on the temporal axis of the video data, forcibly outputs the IN point frame, and if the video frame is positioned after the OUT point frame on the temporal axis of the video data, forcibly outputs the OUT point frame.

4. The playback device according to claim 1, further comprising:
a point correcting unit that corrects any one of the specified IN point and OUT point or both, the point frame deciding unit, when the IN point is corrected by the point correcting unit, deciding the IN point frame based on a time stamp of an old IN point frame decided based on the IN point before being corrected and an address of the IN point after being corrected, and when the OUT point is corrected by the point correcting unit, deciding the OUT point frame based on a time stamp of an old OUT point frame decided based on the OUT point before being corrected and an address of the OUT point after being corrected.

5. The playback device according to claim 1, further comprising:
a frame specifying unit that directly specifies a video frame for any one of the IN point frame and the OUT point frame or both, the point frame deciding unit deciding the video frame specified by the frame specifying unit as any one of the IN point frame and the OUT point frame or both.

6. The playback device according to claim 1, wherein the repeated playback includes a repeat in a fixed playback direction that is a forward direction or a backward direction starting from either the IN point or the OUT point, and a repeat in a switched playback direction that is switched alternatively between the forward direction and the backward direction starting alternatively from the IN point and the OUT point.

7. A repeated playback method for a playback device that enters audio data and video data, synchronizes the audio data with the video data, and performs repeated playback of both data between an IN point that is a repeat start position of the repeated playback and an OUT point that is a repeat end position of the repeated playback specified on a temporal axis of the audio data, the repeated playback method comprising:
deciding a point frame that, from each video frame of the input video data, decides a video frame corresponding to an address of the IN point as an IN point frame and decides a video frame corresponding to an address of the OUT point as an OUT point frame; and limiting an output frame that limits a video frame to be output to a playback segment of the repeated playback to a video frame positioned between the decided IN point frame and OUT point frame on a temporal axis of the video data.

8. A computer program that enables a computer to function as each unit included in the playback device as claimed in claim 1.
